(19) United States
(12) Patent Application Publication
(10) Pub. No.: US 2026/0114421 A1
(43) Pub. Date: Apr. 30, 2026

(54) Animal Feeder

(71) Applicant: Firman A. Troyer, Millersburg, OH (US)

(72) Inventor: Firman A. Troyer, Millersburg, OH (US)

(21) Appl. No.: 19/003,806

(22) Filed: Dec. 27, 2024

Related U.S. Application Data
(60) Provisional application No. 63/556,206, filed on Feb. 21, 2024.

(51) Int. Cl. A01K 5/02

(52) U.S. Cl. CPC A01K 5/0258; A01K 5/0225; A01K 5/0291

(57) ABSTRACT

An animal feeding apparatus for deer and other wildlife. Feed or bait is stored in a fodder storage component and directed to a feeding location remote from the food supply via a fodder delivery component without the need to rely on a gravity feed system. The animal feeding apparatus is camouflaged to prevent deterring animals from approaching the feeding location. An auger of the fodder delivery component directs the flow of feed from the fodder storage component to the feeding location. The animal feeding apparatus is controllable via a controller unit attached to the fodder storage component or remotely via a wireless controller.

### CROSS-REFERENCE TO RELATED APPLICATION

The present application claims priority to, and the benefit of, U.S. Provisional Application No. 63/556,206, which was filed on Feb. 21, 2024 and is incorporated herein by reference in its entirety.

### FIELD OF THE INVENTION

The present invention generally relates to an animal feeding apparatus, and more specifically to an apparatus configured to direct feed from a camouflaged location to a remote feeding area for deer, other wild or domesticated animals. Accordingly, the present specification makes specific reference thereto. However, it is to be appreciated that aspects of the present invention are also equally amenable to other like applications, devices and methods of manufacture.

### BACKGROUND

Many people enjoy feeding animals on their properties or in wild locations. Hunters may also employ deer feeder bait stations to attract deer and other harvestable animals. A deer or animal feeder is a tool used to supply feed, usually in the form of grain, corn, or a blended feed for nutrition, to deer or wildlife in supplemental feed program or as a bait for hunters. The food or fodder is stored in a holding tank or hopper and is distributed via gravity or a scattering device integrated directly into the holding tank or hopper.

Existing bait stations are problematic for hunters. Deer and other wildlife are wary prey and are difficult to effectively attract. Deer are sensitive to unnatural objects, such as a hopper, in the wild and will avoid the feeder if they feel uncomfortable with their surroundings. Existing feeders are often ineffective as bait stations if the deer are fearful as they will not approach. Even existing camouflage feeders are of limited effectiveness as they are still located immediately adjacent to the distributed fodder and are relatively discoverable by the animal.

Therefore, there exists a long felt need in the art for a feeder device designed to attract deer or wildlife without undue suspicion. There is also a long felt need for a device that can deliver food or fodder to a location remote from the feed supply. Additionally, there is a long felt need in the art for a deer bait station that can hold enough food that does not require constant human intervention. Finally, there is a long felt need in the art for an animal feeding apparatus that can attract multiple types of wildlife.

In this manner, the improved animal feeder of the present invention accomplishes all of the foregoing objectives, thereby providing an easy solution to feed deer and other animals. A primary feature of the present invention is a remote feed delivery animal feeder configured for use in the wild. The animal feeder is designed to store a large quantity of fodder in one location and to deliver it to a remote location as needed. Finally, the improved animal feeder of the present invention is capable of improving the likelihood of successfully harvesting deer as the remote feeding location is less likely to deter a deer from approaching the feeding location.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an animal feeding apparatus for providing feed to animals. The animal feeding apparatus is configured to distribute fodder or animal feed remotely from the main fodder supply. The animal feeding apparatus comprises a fodder storage component, a camouflage component, and a fodder delivery component.

The fodder storage component comprises a top opening, a plurality of sidewalls, a narrowing portion, and an outlet. The top opening comprises a lid and provides access to an interior of the fodder storage component. The plurality of sidewalls transition into the narrowing portion with the outlet at a bottom of the narrowing portion. The outlet may comprise a flow control mechanism for allowing a flow of the fodder out of the fodder storage component. The fodder storage component may further comprise a plurality of legs for elevating the fodder storage compartment off of the ground.

The camouflage component is configured to disguise the top opening, the plurality of sidewalls, the narrowing portion, and the outlet. The camouflage component may also disguise the plurality of legs. The camouflage component may be positional over, drape over and around, encapsulate, or otherwise wrap the fodder storage component.

The fodder delivery component is in communication with the fodder storage component and receives a flow of fodder out of the outlet at the bottom of the fodder storage component. The fodder delivery component comprises an inlet, a pipe, a pipe outlet, and an auger. The auger is positional or housed within the pipe. The pipe and the auger may be flexible and are configured to move the fodder through the pipe away from the food storage component to a remote location for discharge through the pipe outlet. The fodder delivery component may further comprise a camouflage element configured to disguise at least a portion of the fodder delivery component.

The animal feeding apparatus further comprises a motor and a control unit. The control unit is in electrical communication with the flow control mechanism and the motor. The motor is configured to operate the auger to move the fodder through the pipe. The animal feeding apparatus may further comprise a battery, a solar panel, or both for providing power to the motor and the control unit.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an animal feeding apparatus of the present invention for feeding animals in accordance with the disclosed architecture;

FIG. 2 illustrates a perspective view of the animal feeding apparatus of the present invention for feeding animals in accordance with the disclosed architecture;

FIG. 3 illustrates a perspective view of the animal feeding apparatus of the present invention for feeding animals in accordance with the disclosed architecture;

FIG. 4 illustrates a perspective view of a camouflage component of the animal feeding apparatus of the present invention for feeding animals in accordance with the disclosed architecture;

FIG. 5 illustrates a side cutaway view of the animal feeding apparatus of the present invention for feeding animals in accordance with the disclosed architecture;

FIG. 6 illustrates a side view of a telescoping pipe of a fodder delivery component of the animal feeding apparatus of the present invention for feeding animals in accordance with the disclosed architecture;

FIG. 7 illustrates a side view of a plurality of extensions of a pipe and a plurality of extensions of an auger of the fodder delivery component of the present invention for feeding animals in accordance with the disclosed architecture.

FIG. 8 illustrates a side view of an outlet of the fodder delivery component of the animal feeding apparatus of the present invention for feeding animals in accordance with the disclosed architecture;

FIG. 9 illustrates side view of a camouflage element of the fodder delivery component of the animal feeding apparatus of the present invention for feeding animals in accordance with the disclosed architecture.

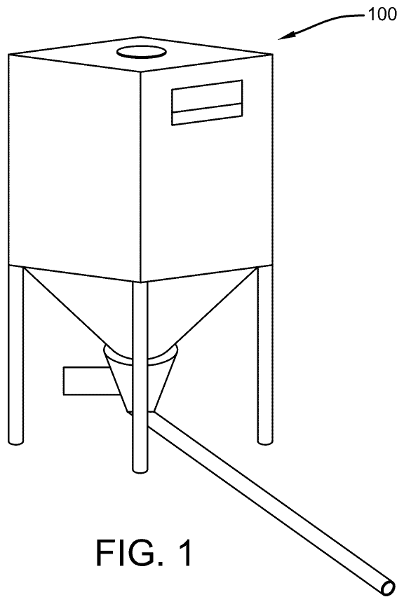

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is an animal feeder configured to deliver fodder to animals remote from the stored fodder. The animal feeder is used to attract and feed deer and other wildlife in addition to domesticated animals. The animal feeder is designed to hold a corn mixture or any other fodder and deliver it remotely to wildlife that are wary and suspicious of unnatural objects in the wild. Ideally, the fodder is delivered to a location that is not visible from the stored fodder.

The animal feeder is designed to make mature deer or other game animals more comfortable and enable better harvesting opportunities for hunters. The animal feeder distributes fodder using a flexible coil auger to supply food from a hidden hopper to a location remote from the food supply. This is different from existing bait feeders that distribute food directly adjacent to the stored fodder supply.

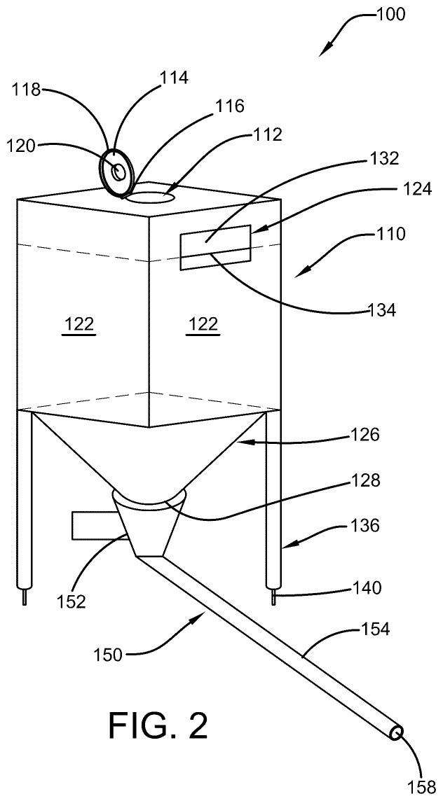

Referring initially to the drawings, FIG. illustrates an animal feeding apparatus 100. As illustrated in FIG. 2, the animal feeding apparatus 100 is configured to distribute fodder or animal feed remotely from a main fodder supply. The animal feeding apparatus 100 comprises a fodder storage component 110, a camouflage component 144, and a fodder delivery component 150. The fodder storage component 110 may be constructed from aluminum, stainless steel, plastic, or any similar material designed to resist exposure from the elements. The fodder storage component 110 may be sized to store up to 2000 pounds of fodder or more.

The fodder storage component 110 comprises a top opening 112, a plurality of sidewalls 122, a narrowing portion 126, and an outlet 128. The fodder storage component 110 may be rectangular, square, oval, cylindrical, or any shape that is desired. The narrowing portion 126 is configured to allow the fodder to gravity feed into the outlet 128 at a bottom of the fodder storage component 110. One of the plurality of sidewalls 122 or the narrowing portion 126 may comprise a viewing window 124 for determining a level of fodder within the fodder storage component. The interior 132 may comprise a plurality of fill level indicators 134 visible via the viewing window 124 for indicating how much feed or fodder is present in the fodder storage component 110. The fodder storage component 110 may be of a single piece or multiple piece construction and may be foldable or collapsible for transport.

The top opening 112 may comprise a lid 114 and provides access to an interior 132 of the fodder storage component 110. The lid 114 may be attached to the top opening 112. The lid 114 may comprise a hinge 116. Alternatively, the lid 114 may completely detachable and may comprise a gasket 118 for creating a weather-tight seal. The lid 114 may be screwed into the top opening 112 or may be friction fitted. The lid 114 may comprise a lid window 120 for viewing the interior 132 of the fodder storage component 110.

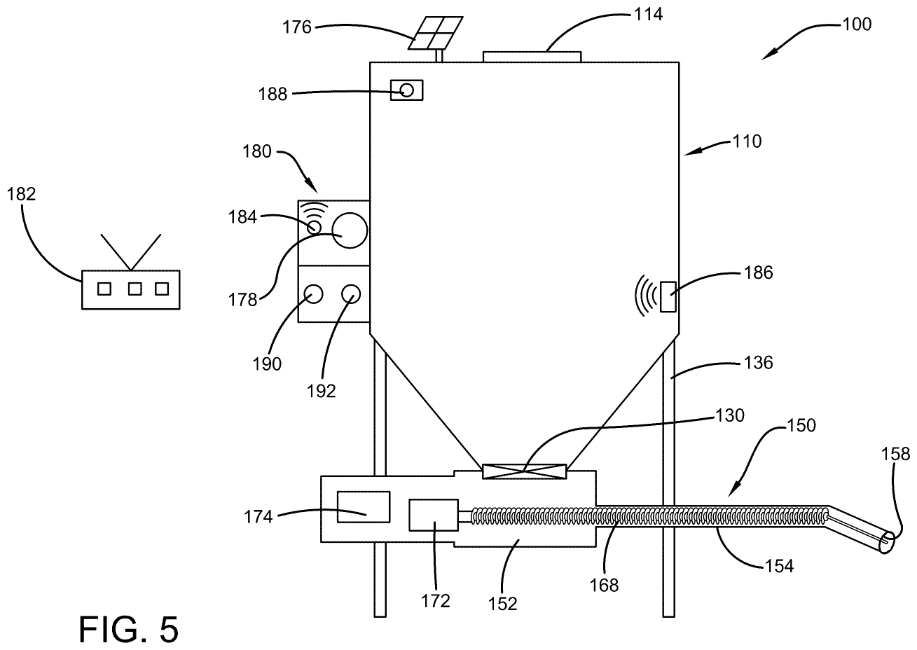

The plurality of sidewalls 122 transition into the narrowing portion 126 with the outlet 128 at the bottom of the narrowing portion 126. As illustrated in FIG. 5, the outlet 128 may comprise a flow control mechanism 130 for allowing and metering a flow of the fodder out of the fodder storage component 110. The flow control mechanism 130 may comprise a valve, a gate, a flapper, or any other similar flow control device that is manually or electronically controllable.

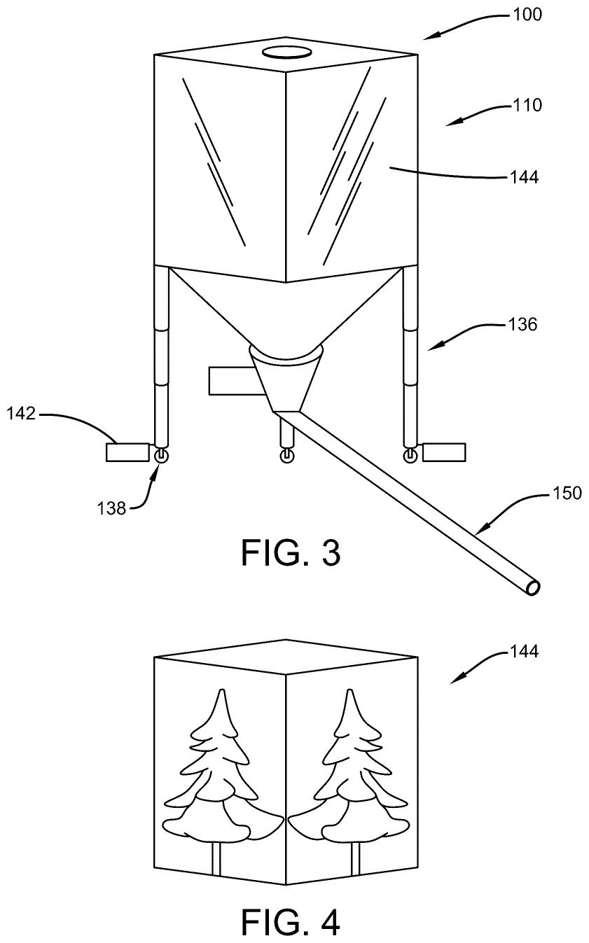

As illustrated in FIGS. 2 and 3, the fodder storage component 110 may further comprise a plurality of legs 136. The plurality of legs 136 are configured to elevate the fodder storage component 110 off of the ground. The plurality of legs 136 may be articulation or adjustable in height, and may be set at different heights to accommodate uneven terrain. The plurality of legs 136 may each comprise a ground securing element 140, such as a stake, a pole, a plate, or a ground anchor. The plurality of legs 136 may each further comprise a weight 132 for keeping the fodder storage component 110 in place. The plurality of legs 136 may each further comprise a wheel 138 that may be attached for transport of the fodder storage component 110.

As illustrated in FIGS. 3 and 4, the camouflage component 144 is configured to disguise the top opening 112, the plurality of sidewalls 122, the narrowing portion 126, and the outlet 128. The camouflage component 144 may also disguise the plurality of legs 136. The camouflage component 144 may be positional over, drape over and around, encapsulate, or otherwise wrap the fodder storage component. The camouflage component 144 may comprise natural material, such as, but not limited to sticks, twigs, branches, shrubbery, plants, flora, logs, rock, stone, hay, grass, and the like, or any combination thereof. The camouflage component 144 may also be a fabric, plastic, or other flexible natural material sheath or cover designed to fit over the fodder storage component 110. Alternatively, the camouflage component 144 may be a vinyl decal, graphic, paint, or similar form fitting covering. The camouflage component 144 may be designed to resemble natural surroundings, such as structures, flora, shrubbery, plants, trees, hay stacks, or any other type of natural imagery.

As illustrated in FIGS. 2, 3, and 5, the fodder delivery component 150 is in communication with the fodder storage component 110. The fodder delivery component 150 receives a flow of fodder out of the outlet 128 at the bottom of the fodder storage component 110. The fodder delivery component 150 comprises an inlet 152, a pipe portion 154, a pipe outlet 158, and an auger 168. The inlet 152 is positioned to receive the fodder that is released via the outlet 128 of the fodder storage component 110. The fodder delivery component 150 is configured to distribute the fodder remotely without relying on gravity.

The auger 168 is positional or housed within the pipe portion 154 and is configured to flex with the pipe portion 154 as needed. The pipe portion 154 and the auger 168 may be flexible and are configured to move the fodder through the pipe portion 154 away from the food storage component 110 to a remote location for discharge through the pipe outlet 158. In one embodiment, the pipe portion 154 may be a low pressure polyethylene two inch pipe. However, this is not meant as a limitation as the pipe portion 154 may be rigid or flexible and smaller or larger in diameter as required. The pipe portion 154 may be between three and 500 feet in length.

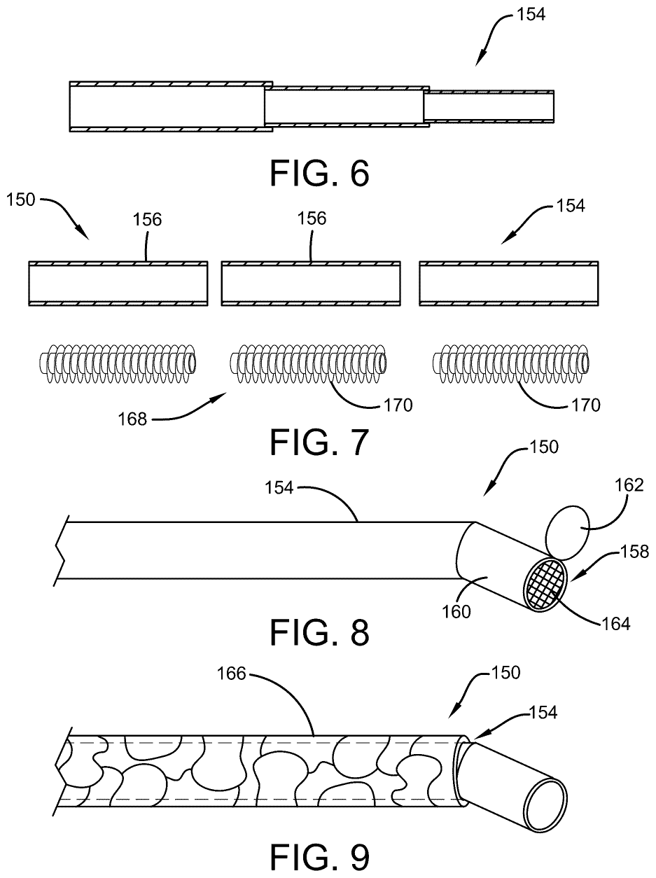

The pipe portion 154 may be adjustable in length comprising a plurality of extensions 156 as illustrated in FIG. 7. Similarly the auger 160 may comprise a plurality of flexible auger extensions 170. The length of the fodder delivery component 150 can then be extendable or retractable as needed. As illustrated in FIG. 6, the pipe portion 154 may alternatively be telescoping.

As illustrated in FIG. 8, the pipe outlet 158 may be angled or adjustable as needed to direct the fodder to specific locations. The pipe outlet 158 may comprise a discharge deflector 160 The deflector 160 is configured to scatter the feed. The pipe outlet 158 may comprise a cap 162. The cap 162 may be a cap with a rotating shaft attachable to the auger 168 to keep the auger 168 in tension. The cap 162 may also be a hinged cap in communication with the flow control mechanism 130 to operate in tandem. The pipe outlet 158 may also comprise a guard 164. The guard 164 may be a grate or rodent protector sized to permit the flow of feed while preventing ingress by small animals.

As illustrated in FIG. 9, the fodder delivery component 150 may further comprise a camouflage element 168. The camouflage element 168 is configured to disguise at least a portion of the fodder delivery component 150. The camouflage element 168 may be a cover designed to fit over or encapsulate any part of the fodder delivery component 150 similarly to the camouflage component, as discussed supra. For example, the camouflage element 168 may be configured to resemble flora. The camouflage element 168 may also be a replica bush or similar natural element disguising the pipe outlet 158.

As illustrated in FIG. 5, the animal feeding apparatus 100 further comprises a motor 172 and a control unit 180. The control unit 180 is in electrical communication with the flow control mechanism 130 and the motor 172. The motor 172 is configured to operate the auger 168 and is powered by a battery 174 in electrical communication with the motor. The animal feeding apparatus 100 may further comprise a solar panel 176. The solar panel 176 is in electrical communication with the battery 174.

The animal feeding apparatus 100 may further comprise a timer 178. The timer 178 is in communication the control unit 180 and may be configured to activate the motor 172 and the flow control mechanism 130 to control release of fodder into the fodder delivery component 150. The animal feeding apparatus 100 may further comprise a wireless controller 182 and an antenna 184. The wireless controller 182 may be configured to remotely operate the animal feeding apparatus 100 via the antenna 184, and may be a mobile application accessible via a smart device or computer.

The animal feeding apparatus 100 may further comprise a sensor 186 for determining when the fodder needs to be replenished. The sensor 186 may be an optical sensor or a pressure sensor. The animal feeding apparatus 100 may further comprise a camera 188 for capturing and transmitting images or video. The animal feeding apparatus 100 may further comprise a GPS component 190. The GPS component 190 may be a GPS tracker or locator. The animal feeding apparatus 100 may further comprise an antitamper component 192. The antitamper component 192 may be configured to emit an audible alert, a visible alert, or both.

It is contemplated that the animal feeding apparatus 100 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the foregoing, the animal feeding apparatus 100 of the present invention and its various structural components can be of any suitable size, shape, and configuration as is known in the art without affecting the overall concept of the invention, provided that it accomplishes the above stated objectives. One of ordinary skill in the art will appreciate that the shape and size of the animal feeding apparatus 100 and its various components and material, as shown in the FIGS. are for illustrative purposes only, and that many other shapes and sizes of the animal feeding apparatus 100 are well within the scope of the present disclosure. Although the dimensions of the animal feeding apparatus 100 are important design parameters, the animal feeding apparatus 100 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An animal feeding apparatus comprising:
a fodder storage component comprising a top opening, a plurality of sidewalls, a narrowing portion, and an outlet;
a camouflage component;
a fodder delivery component comprising an inlet attachable to the outlet of the fodder storage component, a pipe portion, a pipe outlet, and an auger disposed within the pipe portion; and
a motor; and
a control unit in electrical communication with the motor; and
wherein one of the plurality of sidewalls comprises a viewing window;
wherein the fodder storage component further comprises a plurality of articulating legs; and
wherein each of the articulating legs comprises a ground securing plate and a weight.

2. The animal feeding apparatus of claim 1, wherein the top opening comprises a hinged lid.

3. The animal feeding apparatus of claim 1, wherein the outlet of the fodder storage component comprises a flow control mechanism.

4. (canceled)

5. The animal feeding apparatus of claim 1, wherein the plurality of articulating legs are adjustable in height.

6. (canceled)

7. The animal feeding apparatus of claim 1, wherein the camouflage component is a cover configured to encapsulate the plurality of sidewalls and the narrowing portion.

8. The animal feeding apparatus of claim 1, wherein the camouflage component is a wrap configured to cover the plurality of sidewalls and the narrowing portion.

9. The animal feeding apparatus of claim 1, wherein the pipe portion is flexible.

10. The animal feeding apparatus of claim 1, wherein the fodder delivery component further comprises a camouflage element.

11. An animal feeding apparatus comprising:
a fodder storage component comprising a top opening, a plurality of sidewalls, a narrowing portion, an outlet comprising a flow control mechanism, and a feed level sensor;
a camouflage component;
a fodder delivery component comprising an inlet attachable to the outlet of the fodder storage component, a pipe portion, a pipe outlet, a camouflage element, and an auger disposed within the pipe portion; and
a motor;
a control unit in electrical communication with the flow control mechanism and the motor;
a timer in communication with the control unit for activating the motor; and
a camera; and
wherein the top opening comprises a detachable lid comprising a sealing gasket and a lid window.

12. The animal feeding apparatus of claim 11, wherein the pipe portion is a telescoping pipe.

13. The animal feeding apparatus of claim 11, wherein the pipe portion comprises a plurality of pipe sections.

14. The animal feeding apparatus of claim 13, wherein the auger comprises a plurality of auger sections.

15. The animal feeding apparatus of claim 11, wherein the camouflage element is configured to resemble flora.

16. The animal feeding apparatus of claim 11, wherein the pipe outlet comprises a valve.

17. The animal feeding apparatus of claim 11, wherein the pipe outlet comprises a hinged cap.

18. An animal feeding apparatus comprising:
a fodder storage component comprising a top opening, a plurality of sidewalls, a narrowing portion, an outlet comprising a flow control mechanism, and a feed level sensor;
a camouflage component;
a fodder delivery component comprising an inlet attachable to the outlet of the fodder storage component, a pipe portion, a pipe outlet comprising a deflector and a grate, a camouflage element, and an auger disposed within the pipe portion; and
a motor;
a wireless control unit in communication with the flow control mechanism and the motor;
a camera;
a global positioning system tracker; and
an anti-tamper component; and
wherein one of the plurality of sidewalls comprises a viewing window for inspecting a plurality of fill level indicators inside the fodder storage component; and
wherein the pipe outlet further comprises a cap rotatably attached to the auger and configured to keep the auger in tension within the pipe portion.

19. The animal feeding apparatus of claim 18, further comprising a solar panel.

20. The animal feeding apparatus of claim 18, wherein the anti-tamper component is configured to emit an audible alert.
